(19) United States
(12) Patent Application Publication
(10) Pub. No.: US 2023/0089781 A1
(43) Pub. Date: Mar. 23, 2023

(54) SYSTEM AND METHOD FOR MANUFACTURING CALCINED GYPSUM WITH IN-LINE CALCINATION CONTROL DEVICE

(71) Applicant: United States Gypsum Company, Chicago, IL (US)

(72) Inventor: Blair Walker, Almonte (CA)

(73) Assignee: United States Gypsum Company, Chicago, IL (US)

(21) Appl. No.: 17/932,125

(22) Filed: Sep. 14, 2022

Related U.S. Application Data
(60) Provisional application No. 63/245,798, filed on Sep. 17, 2021.

(51) Int. Cl. C04B 11/028

(52) U.S. Cl. CPC C04B 11/028; C04B 2111/0025

(57) ABSTRACT

Embodiments of a system and a method for manufacturing calcined gypsum can include an in-line calcination control device having an x-ray analyzer. The x-ray analyzer is adapted to analyze at least one of the calcined gypsum being discharged from the calciner and the calcined gypsum being fed into a mixer of a gypsum boardline. The x-ray analyzer is configured to determine the proportion of different calcium sulphate phases found therein which can be used to control at last one of the calciner and the boardline.

This patent application claims the benefit of priority to U.S. Provisional Patent Application No. 63/245,798, filed Sep. 17, 2021, and entitled, “System and Method for Manufacturing Calcined Gypsum with In-Line Calcination Control Device,” which is incorporated in its entirety herein by this reference.

### BACKGROUND

The present disclosure relates to systems and methods for calcining gypsum, such as, e.g., is used in continuous cementitious board manufacturing processes, and, more particularly, to a system and method for calcining gypsum which includes an in-line calcination control device adapted to control at least one operating parameter based upon a signal received from an x-ray analyzer.

Calcium sulfate materials are available in several forms or phases that are simplified as follows: calcium sulfate dihydrate—CaSO₄.2H₂O (commonly known as gypsum); calcium sulfate hemihydrate—CaSO₄.½H₂O (commonly known as stucco); and calcium sulfate—CaSO₄ (commonly known as anhydrite). In many types of cementitious articles, set gypsum (calcium sulfate dihydrate) is often a major constituent. For example, set gypsum is a major component of end products created by use of traditional plasters (e.g., plaster-surfaced internal building walls), and also in faced gypsum board employed in typical drywall construction of interior walls and ceilings of buildings. In addition, set gypsum is the major component of gypsum/cellulose fiber composite boards and products, as described in U.S. Pat. No. 5,320,677, for example. Typically, such gypsum-containing cementitious products are made by preparing a mixture of calcined gypsum (comprising calcium sulfate hem ihydrate alpha or beta and/or calcium sulfate anhydrite), water, and other components, as appropriate to form cementitious slurry. The cementitious slurry and desired additives are often blended in a continuous mixer, as described in U.S. Pat. No. 3,359,146, for example.

The mixture typically is cast into a pre-determined shape or onto the surface of a substrate. The calcined gypsum reacts with the water to form a matrix of crystalline hydrated gypsum, i.e., calcium sulfate dihydrate. It is the desired hydration of calcined gypsum that enables the formation of an interlocking matrix of set gypsum, thereby imparting strength to the gypsum structure in the gypsum-containing product.

Calcined gypsum is typically made by crushing gypsum rock and then heating the gypsum at atmospheric pressure to calcine (dehydrate) the calcium sulfate dihydrate into preferably calcium sulfate hemihydrate. In addition to natural gypsum rock, the use of synthetic gypsum, such as, e.g., flue gas desulphurization gypsum or gypsum from chemical processes can be used as well. The calcining of gypsum typically occurs in a large atmospheric pressure kettle containing a mixture of the various phases of the gypsum.

When gypsum, (i.e., calcium sulfate dihydrate) is calcined, water is removed from the calcium sulfate molecular structure. When one and a half molecules of water are removed from the molecular structure of gypsum, the hem ihydrate results, a material used in various compositions in which rehydration occurs during the setting process subsequent to the addition of the water. When two molecules of water are removed from the molecular structure of gypsum, the anhydrite results. Anhydrites formed by calcining at low temperatures are able to rehydrate when exposed to moist conditions. However, if the calcium sulfate is calcined at high temperatures, typically of about 900° F. or more, an insoluble form of calcium sulfate results.

For example, gypsum (CaSO₄.2H₂O) powder, from sources such as rocks of natural gypsum crushed to make gypsum powder or synthetic gypsum made to be a powder, is heated to calcine into stucco, such as by being heated to a temperature of generally about 250° F.-360° F. With appropriate thermal energy, the gypsum powder converts to hem ihydrate (CaSO₄.½H₂O). If the hem ihydrate is exposed to even greater thermal energy, the gypsum can convert to soluble anhydrite (CaSO₄) or insoluble anhydrite (often referred to as “dead burn”). At great enough exposure to thermal energy, some of the CaSO₄ converts to CaO (quicklime), giving the dead burn a higher pH. When calcining gypsum via a process reactor, the primary control mechanism to maintain quality is typically to maintain a material (e.g., stucco) output temperature, of which the material feed to the calciner and/or the heat to the calciner is manipulated to maintain the calciner output control.

The quality of calcined gypsum can be measured in many ways. For example, a manual gravimetric method can be used to measure the amount of crystal combined water in the material sample to provide an indication of the degree of material calcination that occurred. This measure of the degree of calcination can then be used to infer the general phase composition of the calcined gypsum. As a related example, a series of manual gravimetric tests of calcined gypsum that has been hydrated and heated for different periods of time can be used to produce a calculated phase composition of the calcined gypsum.

As another example, thermal temperature profiles of samples of calcined gypsum mixed with water are manually monitored, measured, and analyzed. The water and calcined gypsum produce an exothermic reaction where different temperature rates can be calculated to provide a phase composition of the calcined gypsum.

As yet another example, near infrared (NIR) equipment can be used to measure the amount of crystal combined water in calcined gypsum. The equipment can be used manually or in an inline process (such as is described in International Patent Application No. WO 2018/091062 A1).

With the exception of inline NIR, stucco phase measurements are periodic, manual samples, requiring a period of time for laboratory testing. The manual nature of testing limits the frequency of testing, of which there are periods of time where quality is unknown. Furthermore, when tested, there is a lag in results, both of which limit the capability to control the calcination process and board formation. The NIR inline testing method does not yield true phase composition of the tested material.

In a typical cementitious board manufacturing process such as gypsum wallboard, cementitious board is produced by dispersing calcined gypsum (commonly referred to as “stucco”) in water to form aqueous calcined gypsum slurry. The aqueous calcined gypsum slurry is typically produced in a continuous manner by inserting stucco and water and other additives into a mixer which contains means for agitating the contents to form a uniform gypsum slurry. The slurry is continuously directed toward and through a discharge outlet of the mixer and into a discharge conduit connected to the discharge outlet of the mixer. Aqueous foam can be combined with the aqueous calcined gypsum slurry in the mixer and/or in the discharge conduit. A stream of foamed slurry passes through the discharge conduit from which it is continuously deposited onto a moving web of cover sheet material (i.e., the face sheet) supported by a forming table. The foamed slurry is allowed to spread over the advancing face sheet. A second web of cover sheet material (i.e., the back sheet) is applied to cover the foamed slurry and form a sandwich structure of a continuous wallboard preform. The wallboard preform is subjected to forming, such as at a conventional forming station, to obtain a desired thickness.

The calcined gypsum reacts with the water in the wallboard preform to form a matrix of crystalline hydrated gypsum or calcium sulfate dihydrate and sets as a conveyor moves the wallboard preform down the manufacturing line. The hydration of the calcined gypsum provides for the formation of an interlocking matrix of set gypsum, thereby imparting strength to the gypsum structure in the gypsum-containing product. The product slurry becomes firm as the crystal matrix forms and holds the desired shape.

The quality of the calcined gypsum in terms of its phase composition of dihydrate, hem ihydrate, and anhydrite (both soluble and insoluble) can have an influence on the crystalline matrix formation. The phase composition of the calcined gypsum may call for the adjustment of the concentration of one or more of the various additives known to for use in the board formulation.

After the wallboard preform is cut into segments downstream of the forming station at a point along the line where the preform has set sufficiently, the segments are flipped over, dried (e.g., in a kiln) to drive off excess water, and processed to provide the final wallboard product of desired dimensions. The aqueous foam produces air voids in the set gypsum, thereby reducing the density of the finished product relative to a product made using a similar slurry but without foam. Prior devices and methods for addressing some of the operational problems associated with the production of gypsum wallboard are disclosed in commonly-assigned U.S. Pat. Nos. 5,683,635; 5,643,510; 6,494,609; 6,874,930; 7,007,914; and 7,296,919, which are incorporated by reference.

There is a continued need in the art to provide additional solutions to enhance the production of cementitious articles. For example, there is a continued need for techniques for producing calcined gypsum that yield a consistent proportion of hemihydrate in the output. As another example, there is a continued need for techniques for monitoring and controlling the production of calcined gypsum from a calciner that yields a consistent phase of calcium sulfate, such as hem ihydrate. And for example, there is a continued need for techniques for monitoring the composition phases of calcined gypsum entering a board line mixer and adjusting and controlling the production formulation in response to the composition phases of such calcined gypsum.

It will be appreciated that this background description has been created to aid the reader and is not to be taken as an indication that any of the indicated problems were themselves appreciated in the art. While the described principles can, in some aspects and embodiments, alleviate the problems inherent in other systems, it will be appreciated that the scope of the protected innovation is defined by the attached claims and not by the ability of any disclosed feature to solve any specific problem noted herein.

### SUMMARY

In one aspect, the present disclosure is directed to embodiments of a system for manufacturing calcined gypsum. In embodiments, a system for manufacturing calcined gypsum includes a calcination control device with an x-ray analyzer.

In one embodiment, a system for manufacturing calcined gypsum includes a calcination unit and an in-line calcination control device. The calcination unit includes a calcining chamber and a heating unit associated with the calcining chamber. The calcining chamber includes an inlet for receiving a supply of gypsum therethrough and into the calcining chamber and an outlet for discharging the supply of gypsum from the calcining chamber.

The in-line calcination control device includes an x-ray analyzer and a controller in operable arrangement therewith. The x-ray analyzer has an x-ray source and a detector. The x-ray source is configured to emit an x-ray beam to strike at least a portion of the supply of gypsum in at least one of a position upstream of the inlet of the calcining chamber and a position downstream of the outlet of the calcining chamber. The detector is configured to measure a response of the supply of gypsum to the x-rays emitted from the x-ray source interacting with the gypsum. The x-ray analyzer is configured to generate a calcining control signal indicative of the response measured by the detector. The controller is configured to adjust at least one operating parameter of the calcination unit based upon the calcining control signal received from the x-ray analyzer.

In another aspect, the present disclosure describes embodiments of a method of manufacturing calcined gypsum. In embodiments, a method of manufacturing calcined gypsum includes varying at least one operating parameter based upon a data signal received from an x-ray analyzer.

In yet another aspect, the present disclosure is directed to embodiments of a system for manufacturing a gypsum board. In embodiments, a system for manufacturing a gypsum board includes a board control device with an x-ray analyzer.

In one embodiment, a system for manufacturing a gypsum board includes a mixer, an ingredient supply system, and an in-line board control device.

The mixer is adapted to agitate calcined gypsum and water to form an aqueous gypsum slurry. The ingredient supply system is configured to selectively feed, according to a board formulation, at least water and calcined gypsum to the mixer. The ingredient supply system includes a source of calcined gypsum associated with the mixer to selectively deliver a feed stream of the calcined gypsum thereto.

The in-line board control device includes an x-ray analyzer and a controller in operable arrangement therewith. The x-ray analyzer has an x-ray source and a detector. The x-ray source is configured to emit an x-ray beam to strike at least a portion of the feed stream of calcined gypsum in a position upstream of said at least one inlet of the mixer. The detector is configured to measure a response of the feed stream of calcined gypsum to the x-rays emitted from the x-ray source interacting with the calcined gypsum. The x-ray analyzer is configured to generate a board control signal indicative of the response measured by the detector. The controller is configured to adjust at least one of the board formulation and a board line operational parameter based upon the board control signal received from the x-ray analyzer.

In still another aspect, the present disclosure describes embodiments of a method of manufacturing a gypsum board. In embodiments, a method of manufacturing a gypsum board includes varying at least one operating parameter based upon a data signal received from an x-ray analyzer.

Further and alternative aspects and features of the disclosed principles will be appreciated from the following detailed description and the accompanying drawings. As will be appreciated, the systems and techniques for manufacturing calcined gypsum and gypsum boards that are disclosed herein are capable of being carried out and used in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

The FIGURE is a schematic plan diagram of an embodiment of a system for manufacturing calcined gypsum constructed in accordance with principles of the present disclosure and an embodiment of a system for manufacturing a gypsum board constructed in accordance with principles of the present disclosure that includes an embodiment of a gypsum slurry mixing and dispensing assembly constructed in accordance with principles of the present disclosure.

It should be understood that the drawing is not necessarily to scale and that the disclosed embodiments are illustrated diagrammatically and in partial views. In certain instances, details which are not necessary for an understanding of this disclosure or which render other details difficult to perceive have been omitted. It should be understood that this disclosure is not limited to the particular embodiments illustrated herein.

### DETAILED DESCRIPTION OF EXEMPLARY EMBODIMENTS

The present disclosure provides various embodiments of a system and a method for at least one of manufacturing calcined gypsum and manufacturing a gypsum board that respectively include means and a step for analyzing calcined gypsum to determine the proportion of at least one phase of calcium sulphate (dihydrate, hemihydrate, anhydrate) contained therein. In embodiments of systems and methods for manufacturing calcined gypsum and/or a gypsum board following principles of the present disclosure, an in-line control device is provided that includes at least one x-ray analyzer.

In embodiments, an x-ray analyzer is adapted to analyze at least one of the calcined gypsum being discharged from a calciner and the calcined gypsum being fed into a mixer of a gypsum boardline. The x-ray analyzer is configured to determine the proportion of different calcium sulphate phases found therein which can be used to control at last one of the calciner and the boardline.

In embodiments, the means and step for analyzing calcined gypsum can comprise equipment for using x-ray diffraction (XRD) and/or x-ray florescence (XRF) to analyze a calcium sulfate specimen to measure the presence of different elements and/or molecular compounds via spectrometry. The analysis can be used to determine the composition of materials in the calcined gypsum.

In embodiments, the x-ray analyzer comprises any suitable x-ray analyzer useful in determining at least one characteristic of calcium sulphate. In embodiments, the x-ray analyzer includes an x-ray source and a detector configured to measure the response of the calcium sulphate specimen to the x-rays emitted from the x-ray source interacting with the calcium sulphate specimen.

In embodiments, the x-ray analyzer comprises any suitable XRD analyzer. In embodiments, the x-ray analyzer comprises an XRD analyzer configured to generate x-ray diffraction data that can be used to determine and measure the contents of calcium sulphate, including the proportion of at least one phase of calcium phosphate present in the specimen under analysis.

In embodiments, the x-ray analyzer comprises any suitable XRF analyzer. In embodiments, the x-ray analyzer comprises an XRF analyzer configured to generate x-ray fluorescence data that can be used to determine and measure the contents of calcium sulphate, including the proportion of at least one phase of calcium phosphate present in the specimen under analysis.

X-ray measurements can include known frequencies of peaks that indicate certain calcium sulfate derivates (among other elements and compounds). For example, CaSO₄.2H₂O at 29.0, 31.0, and/or 33.3 degrees two theta; CaSO₄.½H₂O at 29.4, 29.5, and/or 32.5 degrees two theta; CaSO₄O 25.4, and/or 25.5 degrees two theta. These peaks of interest may shift frequencies and/or amplitude when in the presence or absence of various compounds and/or elements.

Certain compounds, such as, salt (e.g., various chloride derivatives) can have a negative influence on calcination and board formation. In embodiments, the x-ray analyzer comprises an XRF analyzer configured to generate x-ray fluorescence data that can be used to determine whether an impurity is present in the calcium sulphate. In embodiments, the XRF analyzer is configured to measure the content of at least one of salt and chloride in the calcium sulphate being analyzed.

In embodiments, the calcination control device includes an in-line XRD analyzer device configured to detect the amount of different phases of calcium sulphate present in a discharge stream from a calciner. In embodiments, the XRD analyzer device can be used with any suitable calciner, such as those commercially available as readily appreciated by one skilled in the art. Examples of such calciners include commercially-available kettles and flash calciners with a bag house discharge.

In embodiments, an XRD analyzer device is located at the discharge of the calciner to monitor the discharge stream of material being discharged from the calciner. In embodiments, the XRD analyzer device is configured to detect the amounts of the following phases of calcium sulphate: dihydrate, hemihydrate, and anhydrate phases. A specially programmed processor can be configured to create a calcining control signal based upon information about the detected phase amounts contained in the x-ray diffraction data. The calcining control signal can be transmitted to a calcining controller which is configured to adjust at least one operating parameter of the calciner based upon the amount of different phases of calcium sulphate detected in the discharge stream, such as, e.g., the feed rate into the calciner and/or the temperature profile of the interior of the calciner. The XRD analyzer device can be used to measure the content of dihydrate, hemihydrate, and anhydrate in the discharge stream from the calciner as part of a feedback loop for control of the calciner. In embodiments, the processor can be a part of the X-ray analyzer or the calcining controller, or can comprise a part of both the X-ray analyzer and the calcining controller.

In embodiments, the processor can be configured to calculate based upon the amounts of dihydrate, hem ihydrate, and anhydrate detected by the XRD analyzer device a calculated starting gypsum purity of the feed material fed into the calciner and a calculated target calcining profile of dihydrate, hemihydrate, and anhydrate. In embodiments, if the amount of anhydrate exceeds a threshold value (e.g., as compared to a calculated or predetermined target value), the calcining control signal generated by the processor can be configured for use by the calcining controller to direct the calciner to cook the feed material less by increasing the feed rate to the calciner and/or by reducing the heat profile of the calciner. If the amount of dihydrate exceeds a threshold value (e.g., as compared to a calculated or predetermined target value), the calcining control signal generated by the processor can be configured for use by the calcining controller to direct the calciner to cook the feed material more by decreasing the feed rate to the calciner and/or by increasing the heat profile of the calciner.

In embodiments, the processor can be configured to use predictive modeling using a database of historical measurement of material and calciner control points to generate the particular calcining control signal to effect the desired calciner control. In embodiments, a bias/re-calibration system can be provided that helps to maintain system measuring accuracy as changes in system or materials change the XRD measuring signals. The bias/recalibration system can include sensor data to build a database and statistical model where a bias (offset) fact under various selected conditions can be determined and applied to the process control algorithm.

In embodiments, an XRD analyzer device is located upstream of the feed inlet of the calciner to monitor the feed stream of material being fed into the calciner. In embodiments, the XRD analyzer device is configured to detect the amounts of the following phases of calcium sulphate in the feed stream: dihydrate, hem ihydrate, and anhydrate phases. In embodiments, the XRD analyzer device is configured to measure purity and at least one impurity of the feed stream (e.g., land plaster). In embodiments, the processor can be configured to calculate based upon the amounts of dihydrate, hemihydrate, and anhydrate detected by the XRD analyzer device in the feed stream and the calciner's set points (either as measured or as known by the set points inputted to the calciner), a calculated target calcining profile of dihydrate, hemihydrate, and anhydrate for the discharge stream. In embodiments, the processor can be configured to use analytic modeling to predict the target calcining profile (i.e., calculated amounts of dihydrate, hemihydrate, and anhydrate in the discharge stream) of the material discharged from the calciner based upon the amounts of dihydrate, hemihydrate, and anhydrate detected by the XRD analyzer device in the feed stream and the calciner's set points. In embodiments, the target calcining profile can be used by the calcining controller to control the calciner feed rate and/or heat input based upon the XRD measurements of the material fed into the calciner to form a feed forward loop. In embodiments, the use of the in-line XRD analyzer device to measure different compositions of gypsum/stuccos can be used by the calcining controller to control the calciner to produce a discharge stream from the calciner meeting a specific quality parameter (e.g., a minimum percentage of hem ihydrate in the discharge stream) and/or to reduce energy usage by the calciner to avoid using more energy than actually need to achieve a desired result.

In embodiments, an XRD analyzer device is located upstream of the mixer at a wet end of a gypsum manufacturing boardline to monitor the stucco composition being fed into the mixer. In embodiments, the XRD analyzer is preferably interposed between a stucco bin and the mixer. The XRD analyzer device can be configured to monitor the composition of the stucco fed into the mixer. The detected amounts of dihydrate, hemihydrate, and anhydrate can be used by a boardline controller to control the board formulation. With the in line XRD analyzer device positioned to monitor the stucco stream being fed to the board mixer, it can provide real time monitoring of stucco quality, which, via a feed forward loop and analytical modeling performed by the processor, can be used by a boardline controller to automatically change the board formulation and/or at least one board line operational parameter. For example, the board formulation can be automatically controlled based upon the x-ray diffraction data from the XRD analyzer device monitoring the stucco feed stream by adjusting the amount of at least one of the water and one or more additives being fed to the board mixer. Examples of additives whose amounts can be adjusted by the boardline controller include one or more accelerators (e.g., a heat-resistant accelerator or landplaster accelerator), retarder, dispersant, soap, and starch. An example of a boardline operational parameter that can be adjusted by the boardline controller includes the board line speed. In embodiments, the use of the in-line XRD analyzer device to monitor the stucco stream being fed to the mixer can be used to enhance the usage of constituent materials comprising the board formulation to reduce raw material costs and/or reduce the occurrence of producing gypsum board that does not satisfy predetermined specifications.

Turning now to the Figure, an embodiment of a system 10 for manufacturing calcined gypsum and for manufacturing a gypsum board constructed in accordance with principles of the present disclosure is shown. The system 10 illustrated in the Figure includes a system 11 for manufacturing calcined gypsum and a system 12 for manufacturing a gypsum board together to form an integrated manufacturing environment. In embodiments following principles of the present disclosure, a system for manufacturing calcined gypsum or a system for manufacturing gypsum board constructed according to principles of the present disclosure can be provided on its own.

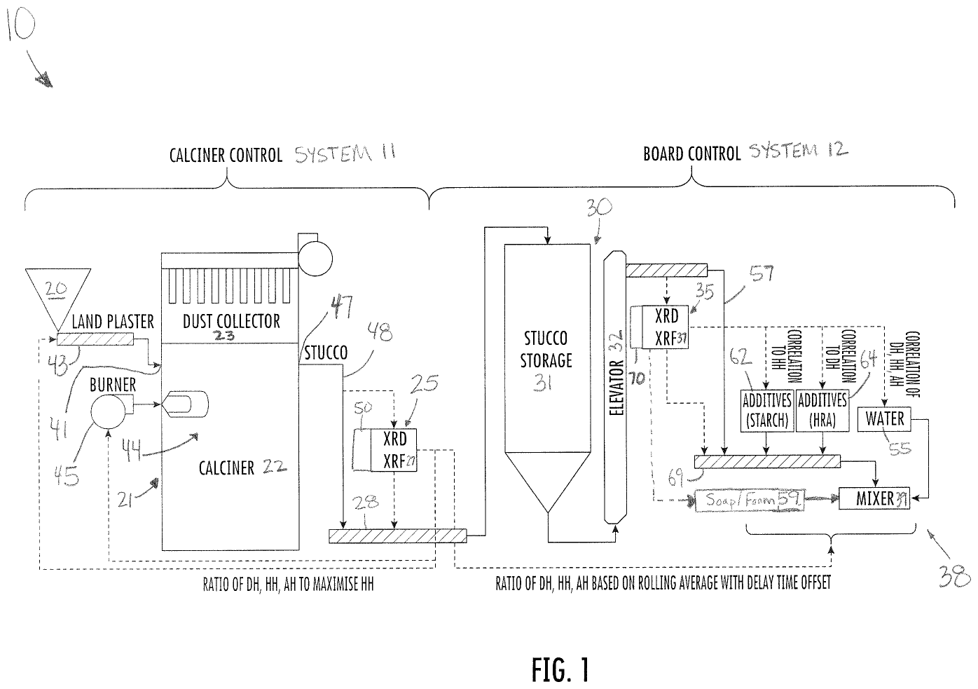

The illustrated system 11 for manufacturing calcined gypsum includes a source of gypsum 20 in the form of land plaster powder, a calcination unit 21 comprising a calciner 22 with an associated dust collector 23, an in-line calcination control device 25 having a first x-ray analyzer 27, and a discharge conveyor 28. The illustrated system for manufacturing a gypsum board 12 includes an ingredient supply system 30 having a stucco bin 31 and an elevator 32, an in-line board formation control device 35 having a second x-ray analyzer 37, and a wet end assembly 38 that includes a mixer 39. It will be understood by one skilled in the art that the system 12 for manufacturing a gypsum board can include other known subsystems of a gypsum boardline that are not shown in FIG. 1, including, e.g., a forming station, a cutting station, a kiln, and suitable conveying equipment downstream of the wet end equipment shown in FIG. 1.

In embodiments, the source of gypsum 20 can be any suitable gypsum, such as, for example land plaster as illustrated in FIG. 1. In embodiments, the source of gypsum 20 is arranged with an inlet 41 of the calciner 22 to provide a feed stream of gypsum to the calciner 22. In the illustrated embodiment, the source of gypsum 20 is associated with a feeder conveyor 43 to selectively deliver the supply of gypsum powder to the calciner 22 via the feeder conveyor 43. The feeder conveyor 43 is configured to direct the feed stream from the source of gypsum 20 to a calcining chamber 44 of the calciner 22 via the inlet 41.

In embodiments, the calcination unit 21 includes the calcining chamber 44 and a heating unit 45 associated with the calcining chamber 44 for providing heat for calcination. The calcining chamber 44 includes the inlet 41 for receiving a supply of gypsum therethrough and into the calcining chamber 44 and an outlet 47 for discharging a discharge stream 48 of calcined gypsum (generally referred to as “stucco”) from the calcining chamber 44.

In embodiments, the calcination unit 21 can comprise any suitable calcination unit, including any suitable commercially-available calciner as one skilled in the art would appreciate, such as, a suitable kettle or flash calciner, for example. Exemplary calcining units comprise kettles, which may be indirectly heated, roller mills, ball mills and hammer mills. In embodiments, the heating unit 45 of the calcination unit 21 includes at least one burner. Each burner can be operated using any suitable fuel, such as, natural gas, petroleum gas, oil, coal, etc. Fuel and air can be introduced to each burner of the heating unit 45 to be burned and the hot gases are then provided in the calcining chamber 44.

The calcined gypsum can be ground or milled to a desired particle size range, which can be performed separately from calcination and can be performed before and/or after calcination. Milling and calcining may be performed in consecutive steps in different units or may be performed in one stage in a single unit. In embodiments a flash calcining unit can be used that performs steps of drying, grounding/milling, and calcining in a single stage in a single machine.

The dust collector 23 is arranged with the calciner 22 to collect dust emitted therefrom. In embodiments, the dust collector 23 can be any suitable dust collector suitable for abating the amount of dust emitted from the calciner 22.

The in-line calcination control device 25 includes the x-ray analyzer 27 and a controller 50 in operable arrangement therewith. The first x-ray analyzer 27 is arranged with the discharge stream 48 of the calciner 22. In embodiments, the in-line calcination control device 25 is arranged so that the discharge stream 48 of the calciner 22 interacts with the in-line calcination control device 25 in a real-time manner and at a position after which the discharge stream 48 has been ground or milled to a desired particle size range.

The first x-ray analyzer 27 has an x-ray source and a detector. In embodiments, the x-ray source is configured to emit an x-ray beam to strike at least a portion of the supply of gypsum 20 in at least one of a position upstream of the inlet 41 of the calcining chamber 44 and a position downstream of the outlet 47 of the calcining chamber 44. The detector is configured to measure a response of the supply of gypsum to the x-rays emitted from the x-ray source interacting with the gypsum.

The first x-ray analyzer 27 is configured to generate a calcining control signal indicative of the response measured by the detector. The controller 50 is configured to adjust at least one operating parameter of the calcination unit 21 based upon the calcining control signal received from the first x-ray analyzer 27.

In embodiments, the calcining control signal generated by the x-ray analyzer 27 is indicative of the amounts of dihydrate, hemihydrate, and anhydrate phases in the supply of gypsum powder. In embodiments, the calcining control signal generated by the x-ray analyzer 27 is indicative of the purity of the supply of gypsum, including whether at least one impurity is present in the supply of gypsum.

In embodiments, the first x-ray analyzer 27 can comprise at least one of an XRD analyzer device and an XRF analyzer device. In embodiments, the first x-ray analyzer 27 comprises both an XRD analyzer device and an XRF analyzer device.

In embodiments, the x-ray analyzer 27 comprises an XRD analyzer configured to generate x-ray diffraction data and to generate, using the x-ray diffraction data, the calcining control signal. In embodiments, the calcining control signal generated is indicative of the contents of the supply of gypsum, including a proportion of at least one phase of calcium phosphate present in the supply of gypsum.

In embodiments, the x-ray analyzer 27 comprises an XRF analyzer configured to generate x-ray fluorescence data and to generate, using the x-ray diffraction data, the calcining control signal. The calcining control signal is indicative of the contents of the supply of gypsum, including a proportion of at least one phase of calcium phosphate present in the supply of gypsum.

In embodiments, the x-ray analyzer 27 comprises an XRF analyzer configured to generate x-ray fluorescence data and to generate, using the x-ray diffraction data, the calcining control signal. The calcining control signal is indicative of the contents of the supply of gypsum powder, including whether an impurity is present in the supply of gypsum powder. In embodiments, the impurity comprises at least one of salt and chloride.

In embodiments, the first x-ray analyzer 27 is in electrical communication, via the controller 50, with the heating unit 45 of the calcination unit 21 and/or the feeder conveyor 43 to form a feedback control loop based upon the measured amounts of dihydrate, hem ihydrate, and anhydrate in the discharge stream 48 from the calciner 22 according to principles discussed herein. In embodiments, the controller 50 is configured to adjust at least one of a feed rate of the supply of gypsum into the calcining chamber 44 and a temperature profile of the calcining chamber 44 based upon the calcining control signal received from the first x-ray analyzer 27. In embodiments, the controller 50 is configured to control at least one of the feeder conveyor 43 and the source of gypsum 20 to selectively adjust the feed rate of the supply of gypsum based upon the calcining control signal.

In embodiments, the feedback control loop provided by the first x-ray analyzer 27 can be used with a variety of calcium sulphate materials, to produce a discharge stream 48 from the calciner 22 comprising one or more of the following: water-soluble calcium sulfate anhydrite, calcium sulfate a-hemihydrate, calcium sulfate β-hem ihydrate, natural, synthetic or chemically modified calcium sulfate hem ihydrate, calcium sulfate dihydrate, and mixtures thereof. In one aspect, the discharge stream 48 desirably comprises calcined gypsum, such as in the form of calcium sulfate alpha hem ihydrate, calcium sulfate beta hem ihydrate, and/or calcium sulfate anhydrite. The calcined gypsum can be fibrous in some embodiments and nonfibrous in other embodiments. In embodiments, the calcined gypsum can include at least about 50% beta calcium sulfate hemihydrate. In other embodiments, the calcined gypsum can include at least about 86% beta calcium sulfate hem ihydrate.

After calcination, the calcined gypsum can be discharged in the discharge stream 48 from the calcination unit 21. In the illustrated embodiment, the discharge conveyor 28 transports the discharge stream 48 of calcined gypsum from the calcination unit 21 to the stucco bin 31. In other embodiment, the calcined gypsum can be transported directly to the boardline without passing through a stucco bin. The discharge stream 48 from the calciner 22 can be fed to the stucco bin 31 (if present) for storage until the boardline calls for a supply of stucco. In the illustrated embodiment, the first X-ray analyzer 27 is located downstream of the outlet 47 of the calcining chamber 44 and is configured to monitor at least a portion of the discharge stream 48 of calcined gypsum being discharged from the calcination unit 21.

In embodiments, the ingredient supply system 30 is configured to selectively feed, according to a board formulation, at least water 55 and a feed stream 57 of calcined gypsum to at least one inlet of the mixer 39. The illustrated ingredient supply system 30 includes a source of calcined gypsum 31 associated with the mixer 39 to selectively deliver the feed stream 57 of calcined gypsum to at least one inlet of the mixer 39, a source of water 55, a source of soap/foam 59, a source of starch 62, and a source of heat-resistant accelerator 64. The ingredient supply system 30 can include a foam generator system suitable for delivering the supply of foam 59 to the mixer 39 and/or discharge conduit of the mixer 39 as is well understood by one skilled in the art. In other embodiments, the ingredient supply system 30 can include any suitable dry ingredient and/or suitable liquid ingredient as will be appreciated by one skilled in the art.

The illustrated ingredient supply system 30 includes the stucco bin 31 and the elevator 32. The stucco bin 31 can be associated with the elevator 32 in order to selectively supply the wet end assembly 38 with the feed stream 57 of calcined gypsum. The elevator 32 is disposed between the stucco bin 31 and the second x-ray analyzer 37. The elevator 32 is configured to receive the feed stream 57 of calcined gypsum from the stucco bin 31, convey the feed stream 57 of calcined gypsum from the stucco bin 31 to an elevated position, and discharge the feed stream 57 of calcined gypsum therefrom so that the feed stream 57 can be conveyed to the mixer 39 via the effect of gravity upon it. In embodiments, the ingredient supply system 30 can include a suitable device 69 such as an auger, screw, or similar device for incorporating the feed stream 57 of calcined gypsum and at least one other ingredient of the board formulation together for introduction into the mixer 39 and appropriate conveyor and/or ductwork for facilitating the conveyance of at least one ingredient to an inlet of the mixer.

The in-line board control device 35 includes the second x-ray analyzer 37 and a controller 70 in operable arrangement therewith. The second x-ray analyzer 37 has an x-ray source and a detector. The x-ray source is configured to emit an x-ray beam to strike at least a portion of the feed stream 57 of calcined gypsum in a position upstream of the mixer 39. The detector is configured to measure a response of the feed stream 57 of calcined gypsum to the x-rays emitted from the x-ray source interacting with the calcined gypsum. The x-ray analyzer 37 is configured to generate a board control signal indicative of the response measured by the detector. The controller 70 is configured to adjust at least one of the board formulation and a board line operational parameter based upon the board control signal received from the x-ray analyzer 37.

In embodiments, the board control signal generated by the x-ray analyzer 37 is indicative of the amounts of dihydrate, hem ihydrate, and anhydrate phases in the feed stream of calcined gypsum. In embodiments, the board control signal generated by the x-ray analyzer 37 is indicative of the purity of the feed stream of calcined gypsum, including whether at least one impurity is present in the feed stream 57 of calcined gypsum.

The second x-ray analyzer 37 is preferably disposed downstream of the elevator and is arranged to monitor the stucco stream being fed to the wet end assembly, in particular the mixer of the wet end assembly. In embodiments, the wet end assembly 38 can include any suitable equipment adapted to mix and/or assemble the constituent materials forming the gypsum board.

In embodiments, the second x-ray analyzer 37 can comprise at least one of an XRD analyzer device and an XRF analyzer device. In the illustrated embodiment, the second x-ray analyzer comprises both an XRD analyzer device and an XRF analyzer device. The second x-ray analyzer 37 is in electrical communication with the boardline controller 70 which is configured to regulate the board formulation and the operation of boardline equipment, including the ingredient supply system 30, the mixer 39, and the foam injection system 59.

In embodiments, the second x-ray analyzer 37 comprises an XRD analyzer configured to generate x-ray diffraction data and to generate, using the x-ray diffraction data, the board control signal. The board control signal is indicative of the contents of the feed stream of calcined gypsum, including a proportion of at least one phase of calcium phosphate present in the feed stream of calcined gypsum.

In embodiments, the XRD analyzer of the second x-ray analyzer 37 is in electrical communication with the boardline controller 70 to form a forward control loop based upon the measured amounts of dihydrate, hem ihydrate, and anhydrate in the stucco stream being fed to the mixer. For example, the amount of starch in the board formulation can be regulated according to the amount of hem ihydrate detected in the stucco stream. The amount of accelerator in the board formulation can be adjusted according to the amount of dihydrate detected in the stucco stream. The amount of water in the board formulation can be adjusted according to the proportional amounts of dihydrate, hem ihydrate, and anhydrate detected in the stucco stream.

In embodiments, the second x-ray analyzer 37 comprises an XRF analyzer configured to generate x-ray fluorescence data and to generate, using the x-ray diffraction data, the board control signal. The board control signal is indicative of the contents of the feed stream of calcined gypsum, including a proportion of at least one phase of calcium phosphate present in the feed stream of calcined gypsum.

In embodiments, the second x-ray analyzer 37 comprises an XRF analyzer configured to generate x-ray fluorescence data and to generate, using the x-ray diffraction data, the board control signal. The board control signal is indicative of the contents of the feed stream of calcined gypsum, including whether an impurity is present in the feed stream of calcined gypsum. In embodiments, the impurity comprises at least one of salt and chloride.

In embodiments, the XRF analyzer device of the second x-ray analyzer 37 can be used by the processor of the second x-ray analyzer to determine whether the stucco stream contains an amount of salt and/or chloride. The second x-ray analyzer 37 can send a board control signal to the boardline controller 70 in the event that salt/chloride is detected in the stucco stream to the mixer over a certain threshold to regulate the operation of the foam injection system 59 arranged with the mixer 39 and/or the discharge conduit thereof.

The mixer 39 is adapted to agitate the feed stream 57, the water 55, and other known additives supplied by the ingredient supply system 30 to form an aqueous gypsum slurry which is configured to form the core of the gypsum board. In embodiments, the mixer 39 includes a housing and an agitator disposed within the housing. The agitator can be configured to agitate water and calcined gypsum to form an aqueous gypsum slurry. In embodiments, the housing has at least one inlet for delivering the water and the calcined gypsum to the mixer 39 and an outlet for discharging the aqueous gypsum slurry from the housing of the mixer 39.

In embodiments, the housing defines a mixing chamber, a water inlet, and a calcined gypsum inlet. The water inlet and the calcined gypsum inlet are in communication with the mixing chamber. In embodiments, the housing defines a plurality of water inlets that are arranged near the calcined gypsum inlet. In embodiments, the housing defines one or more other water inlets located closer to the radial periphery of the housing. In embodiments, the housing defines at least one additive inlet for receiving an additive therethrough.

In embodiments, the mixer 39 is in fluid communication with a discharge conduit and the foam injection system 59. Both the water and the stucco stream can be supplied to the mixer 39 via one or more inlets as is known in the art. In embodiments, any other suitable slurry additive can be supplied to the mixer 39. The weight ratio of water to calcined gypsum can be any suitable ratio, although, as one of ordinary skill in the art will appreciate, lower ratios can be more efficient because less excess water will remain after the hydration process of the stucco is completed to be driven off during manufacture, thereby conserving energy. In some embodiments, the gypsum slurry can be prepared by combining water and calcined gypsum in a suitable water to stucco weight ratio for board production depending on products, such as in a range between about 1:6 and about 1:1, e.g., about 2:3.as is known in the art of manufacturing cementitious products.

In embodiments, one or more inlets can be provided for introducing other additives into the mixer 39 in addition to foam that are commonly used in the production of gypsum board. Such additives include structural additives including mineral wool, continuous or chopped glass fibers (also referred to as fiberglass), perlite, clay, vermiculite, calcium carbonate, polyester, and paper fiber, as well as chemical additives such as foaming agents, fillers, accelerators, sugar, enhancing agents such as phosphates, phosphonates, borates and the like, retarders, binders (e.g., starch and latex), colorants, fungicides, biocides, hydrophobic agent, such as a silicone-based material (e.g., a silane, siloxane, or silicone-resin matrix), and the like. Examples of the use of some of these and other additives are described, for instance, in U.S. Pat. Nos. 6,342,284; 6,632,550; 6,800,131; 5,643,510; 5,714,001; and 6,774,146; and U.S. Patent Application Publication Nos. 2002/0045074; 2004/0231916; 2005/0019618; 2006/0035112; and 2007/0022913.

In embodiments, the in-line calcination control device 25 and the in-line board formation control device 35 can include a processor and a non-transitory computer readable medium bearing a calciner control application and a boardline control application, respectively. In embodiments, each of the first x-ray analyzer 27 and the second x-ray analyzer 37 includes the processor and the non-transitory computer readable medium bearing the calciner control application and the boardline control application, respectively. In other embodiments, each of the calcining controller 50 and the boardline controller 70 includes the processor and the non-transitory computer readable medium bearing the calciner control application and the boardline control application, respectively. In other embodiments, the processor respectively comprises a part of the first x-ray analyzer 27 and the second x-ray analyzer 37 and the respective controller 50, 70. In embodiments, the in-line calcination control device 25 and the in-line board formation control device 35 can comprise an integrated device configured to perform both calciner control operations and boardline control operations, positioned at a point between the calciner and the mixer.

The processor is in communication with the associated x-ray analyzer device(s) 27, 37 to receive the x-ray diffraction data/x-ray fluorescence data therefrom. In embodiments, the processor is programmed with at least one of the particular control applications.

In embodiments, the in-line calcination control device 25 and the in-line board formation control device 35 can include a user input and/or interface device having one or more user-actuated mechanisms (e.g., one or more push buttons, slide bars, rotatable knobs, a keyboard, and a mouse) adapted to generate one or more user actuated input control signals. In embodiments, the in-line calcination control device 25 and the in-line board formation control device 35 can be configured to include one or more other user-activated mechanisms to provide various other control functions for the calciner and/or boardline, as will be appreciated by one skilled in the art. The in-line calcination control device 25 and the in-line board formation control device 35 can include a display device adapted to display a graphical user interface. The graphical user interface can be configured to function as both a user input device and a display device in embodiments. In embodiments, the display device can comprise a touch screen device adapted to receive input signals from a user touching different parts of the display screen. In embodiments, processor of the in-line calcination control device 25 and/or the in-line board formation control device 35 can be in the form of a smart phone, a tablet, a personal digital assistant (e.g., a wireless, mobile device), a laptop computer, a desktop computer, or other type of device. In embodiments, the processor of the in-line calcination control device 25 and the in-line board formation control device 35 can comprise the same device or be formed from a set of equipment.

In embodiments, the processor is in operable arrangement with the non-transitory computer-readable medium to execute the control application contained thereon. The processor can be in operable arrangement with a display device to selectively display output information from the control application and/or to receive input information from a graphical user interface displayed by the display device.

In embodiments, the processor can comprise any suitable computing device, such as, a microprocessor, a mainframe computer, a digital signal processor, a portable computing device, a personal organizer, a device controller, a logic device (e.g., a programmable logic device configured to perform processing functions), a digital signal processing (DSP) device, or a computational engine within an appliance. In embodiments, the processor also includes one or more additional input devices (e.g., a keyboard and a mouse).

The processor can have one or more memory devices associated therewith to store data and information. The one or more memory devices can include any suitable type, including volatile and non-volatile memory devices, such as RAM (Random Access Memory), ROM (Read-Only Memory), EEPROM (Electrically-Erasable Programmable Read-Only Memory), flash memory, etc. In one embodiment, the processor is adapted to execute programming stored upon a non-transitory computer readable medium to perform various methods, processes, and modes of operations in a manner following principles of the present disclosure.

In embodiments, the non-transitory computer readable medium can contain a control application that is configured to implement an embodiment of a method for manufacturing calcined gypsum and/or manufacturing gypsum board according to principles of the present disclosure. In embodiments, the control application includes a graphical user interface that can be displayed by the display device. The graphical user interface can be used to facilitate the inputting of commands and data by a user to the control application and to display outputs generated by the control application.

The control application can be stored upon any suitable computer-readable storage medium. For example, in embodiments, a control program following principles of the present disclosure can be stored upon a hard drive, floppy disk, CD-ROM drive, tape drive, zip drive, flash drive, optical storage device, magnetic storage device, and the like.

In embodiments, any suitable mixer (e.g., a pin mixer) can be used in the wet end. In embodiments, the mixer can be a suitable, commercially-available mixer, as is known in the gypsum board manufacturing art, such as, one available from Gypsum Technologies Inc. or John Broeders Machine both of Ontario, Canada, for example.

In embodiments, the agitator is rotatably mounted within the mixing chamber. The agitator can include a radially extending disc to which is attached a generally vertical drive shaft positioned along a normal axis, which is perpendicular to both a machine direction and a cross-machine direction. The drive shaft can extend through the upper wall of the main mixer. The drive shaft can be connected to a conventional drive source, such as, a motor, for example, for rotating the drive shaft at a suitable speed (e.g., 275-300 rpm) appropriate for rotating the agitator to mix the contents of the mixing chamber of the main mixer. This rotation directs the resulting aqueous slurry in a generally centrifugal direction, such as in a clockwise outward spiral. It should be appreciated that this discussion of an agitator is meant only to indicate the basic principles of agitators commonly employed in gypsum slurry mixing chambers known in the art. Alternative agitator designs, including those employing pins, paddles, plows, rings, etc., are contemplated.

In embodiments, the weight ratio of water to calcined gypsum can be any suitable ratio, although, as one of ordinary skill in the art will appreciate, lower ratios can be more efficient because less excess water will remain after the hydration process of the stucco is completed to be driven off during manufacture, thereby conserving energy. In some embodiments, the gypsum slurry can be prepared by combining water and calcined gypsum in a suitable water to stucco weight ratio for board production depending on products, such as in a range between about 1:6 and about 1:1, e.g., about 2:3.

In embodiments, a slurry discharge conduit is provided that is in fluid communication with the main mixer. In embodiments, the slurry discharge conduit can comprise any suitable discharge conduit component as will be appreciated by one skilled in the art. For example, the discharge conduit can includes a delivery conduit, a foam injection body of the foam injection system, a flow-modifying element, and a slurry distributor.

In embodiments, the discharge conduit is in fluid communication with the main mixer and is configured to deliver a main flow of the core slurry from the main mixer downstream to a further manufacturing station. In embodiments, the discharge conduit is adapted to deposit the core slurry upon a web of cover sheet material advancing in a machine direction. In this arrangement, the gypsum board is produced “face down” such that the advancing web serves as the “face” cover sheet of the finished board. In embodiments, the core slurry can be discharged from the discharge conduit in an outlet flow direction substantially along the machine direction in which the moving face cover sheet is travelling.

In embodiments, the delivery conduit can be made from any suitable material and can have different shapes. In some embodiments, the delivery conduit can comprise a flexible conduit.

In embodiments, one or more flow-modifying elements can be associated with the discharge conduit and adapted to modify the flow of the core slurry discharged from the main mixer through the discharge conduit. In embodiments, the flow-modifying element is disposed downstream of the foam injection body and the aqueous foam supply conduit relative to a flow direction of the flow of cementitious slurry from the main mixer through the discharge conduit. The flow-modifying element(s) can be used to control an operating characteristic of the flow of the core slurry moving through the discharge conduit. Examples of suitable flow-modifying elements include volume restrictors, pressure reducers, constrictor valves, canisters etc., including those described in U.S. Pat. Nos. 6,494,609; 6,874,930; 7,007,914; and 7,296,919, for example.

In embodiments, the slurry distributor can be any suitable terminal portion of a conventional discharge conduit, such as a length of conduit in the form of a flexible hose or a component commonly referred to as a “boot.” In embodiments, the boot can be in the form of a multi-leg discharge boot.

In yet other embodiments, the slurry distributor of the discharge conduit 112 can be similar to one as shown and described in U.S. Patent Application Publication Nos. 2012/0168527; 2012/0170403; 2013/0098268; 2013/0099027; 2013/0099418; 2013/0100759; 2013/0216717; 2013/0233880; and 2013/0308411, for example. In some of such embodiments, the discharge conduit can include suitable components for splitting a main flow of cementitious slurry from the main mixer into two flows which are re-combined in the slurry distributor.

In embodiments, a foam injection system is arranged with at least one of the main mixer and the slurry discharge conduit. The foam injection system can include a foam source (e.g., such as a foam generation system configured as known in the art), a foam supply conduit, and a suitable foam injection body.

In embodiments, any suitable foam source can be used. Preferably, the aqueous foam is produced in a continuous manner in which a stream of a mix of foaming agent and water is directed to a foam generator, and a stream of the resultant aqueous foam leaves the generator and is directed to and mixed with the cementitious slurry. In embodiments, any suitable foaming agent can be used. Some examples of suitable foaming agents are described in U.S. Pat. Nos. 5,683,635 and 5,643,510, for example.

In embodiments, the aqueous foam supply conduit can be in fluid communication with at least one of the main mixer and the delivery conduit. An aqueous foam from the foam source can be added to the constituent materials through the foam supply conduit at any suitable location downstream of the main mixer in the discharge conduit and/or in the main mixer itself to form a foamed cementitious slurry. In the illustrated embodiment, the foam supply conduit is disposed downstream of the main mixer. In embodiments, the aqueous foam supply conduit has a manifold-type arrangement for supplying foam to a number of foam injection ports within the foam injection body, which can be in the form of an injection ring or block, associated with the discharge conduit, such as is described in U.S. Pat. No. 6,874,930, for example.

In other embodiments, one or more secondary foam supply conduits can be provided, and each of which is in fluid communication with the main mixer. In yet other embodiments, the aqueous foam supply conduit(s) can be in fluid communication with the main mixer alone. As will be appreciated by those skilled in the art, the means for introducing aqueous foam into the gypsum slurry, including its relative location in the assembly, can be varied and/or optimized to provide a uniform dispersion of aqueous foam in the core slurry to produce board that is fit for its intended purpose.

In embodiments, the foam injection body comprises a part of at least one of the main mixer and the slurry discharge conduit. The illustrated foam injection body comprises a part of the discharge conduit.

In embodiments, one or both of the cover sheets of the gypsum board can be treated with a relatively denser layer of gypsum slurry (relative to the core slurry from which the board core is made), often referred to as a “skim coat” in the art, if desired. To that end, in embodiments, the main mixer can include an auxiliary conduit that is adapted to deposit a stream of dense aqueous cementitious slurry that is relatively denser than the core slurry deposited from the discharge conduit. In embodiments, the denser layer can be provided at the edges of the board, as well, using known equipment and techniques.

In embodiments, the auxiliary conduit comprises one for depositing a skim coat layer to a back cover sheet. The main mixer can direct a flow of aqueous calcined gypsum slurry through the auxiliary conduit (i.e., a “back skim coat stream”) that is relatively denser than the main flow of the foamed core slurry dispensed from the discharge conduit. A back skim coat station can include suitable equipment for applying the back skim coat, such as, for example, a back skim coat roller disposed over a support element such that the second cover sheet being dispensed from a second roll is disposed therebetween. The auxiliary conduit can deposit the back skim coat stream upon the moving second cover sheet upstream (in the direction of movement of the second cover sheet) of the back skim coat roller that is adapted to apply a skim coat layer to the second cover sheet being dispensed from the second roll as is known in the art.

In other embodiments, separate auxiliary conduits can be connected to the main mixer to deliver one or more separate streams to the face cover sheet. Other suitable equipment (such as auxiliary mixers) can be provided in the auxiliary conduits to help make the slurry therein denser, such as by mechanically breaking up foam in the slurry and/or by chemically breaking up the foam through use of a suitable de-foaming agent inserted into the auxiliary conduit(s) through a suitable inlet. In other embodiments, an auxiliary conduit can direct slurry from the main mixer into a second mixer and/or include a suitable inlet for incorporating at least one enhancing additive therein to form a strengthened slurry having at least one ingredient which is more concentrated in the strengthened slurry than in the core slurry to form a slurry suitable for use as a concentrated layer and/or as edge layer(s).

In embodiments, the wet end assembly can be equipped with other conventional equipment as is known in the art. The wet end assembly is configured to mix and assemble constituent materials together such that a continuous gypsum board having a predetermined nominal thickness can be produced from a forming station along a conveyor in the machine direction toward a cutting station. In embodiments, the system for manufacturing a gypsum board can include other components and stations. For example, in embodiments, the system can include a transfer system, including a board inverter; a kiln; and a bundler and taping station, all downstream of the cutting station. In embodiments, the board manufacturing process can be completed using any suitable techniques and equipment which are known to those skilled in the art.

All references cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for manufacturing calcined gypsum, the system comprising:
a calcination unit, the calcination unit including a calcining chamber and a heating unit associated with the calcining chamber, the calcining chamber including an inlet for receiving a supply of gypsum therethrough and into the calcining chamber and an outlet for discharging the supply of gypsum from the calcining chamber;
an in-line calcination control device, the in-line calcination control device including an x-ray analyzer and a controller in operable arrangement therewith, wherein:
the x-ray analyzer has an x-ray source and a detector, the x-ray source configured to emit an x-ray beam to strike at least a portion of the supply of gypsum in at least one of a position upstream of the inlet of the calcining chamber and a position downstream of the outlet of the calcining chamber, and the detector configured to measure a response of the supply of gypsum to the x-rays emitted from the x-ray source interacting with the gypsum, the x-ray analyzer configured to generate a calcining control signal indicative of the response measured by the detector, and
the controller configured to adjust at least one operating parameter of the calcination unit based upon the calcining control signal received from the x-ray analyzer.

2. The system for manufacturing calcined gypsum according to claim 1, wherein the calcining control signal generated by the x-ray analyzer is indicative of the amounts of dihydrate, hem ihydrate, and anhydrate phases in the supply of gypsum.

3. The system for manufacturing calcined gypsum according to claim 1, wherein the calcining control signal generated by the x-ray analyzer is indicative of the purity of the supply of gypsum, including whether at least one impurity is present in the supply of gypsum.

4. The system for manufacturing calcined gypsum according to claim 1, wherein the controller is configured to adjust at least one of a feed rate of the supply of gypsum into the calcining chamber and a temperature profile of the calcining chamber based upon the calcining control signal received from the x-ray analyzer.

5. The system for manufacturing calcined gypsum according to claim 4, further comprising:
a feeder conveyor, the feeder conveyor configured to feed the supply of gypsum to the calcining chamber;
a source of gypsum, the source of gypsum associated with the feeder conveyor to selectively deliver the supply of gypsum to the feeder conveyor;
wherein the controller is configured to control at least one of the feeder conveyor and the source of gypsum to selectively adjust the feed rate of the supply of gypsum based upon the calcining control signal.

6. The system for manufacturing calcined gypsum according to claim 1, wherein the x-ray analyzer comprises an XRD analyzer configured to generate x-ray diffraction data and to generate, using the x-ray diffraction data, the calcining control signal, the calcining control signal indicative of the contents of the supply of gypsum, including a proportion of at least one phase of calcium phosphate present in the supply of gypsum.

7. The system for manufacturing calcined gypsum according to claim 6, wherein the XRD analyzer device is located downstream of the outlet of the calcining chamber and configured to monitor at least a portion of a discharge stream of calcined gypsum being discharged from the calcination unit.

8. The system for manufacturing calcined gypsum according to claim 1, wherein the x-ray analyzer comprises an XRF analyzer configured to generate x-ray fluorescence data and to generate, using the x-ray diffraction data, the calcining control signal, the calcining control signal indicative of the contents of the supply of gypsum, including a proportion of at least one phase of calcium phosphate present in the supply of gypsum.

9. The system for manufacturing calcined gypsum according to claim 1, wherein the x-ray analyzer comprises an XRF analyzer configured to generate x-ray fluorescence data and to generate, using the x-ray diffraction data, the calcining control signal, the calcining control signal indicative of the contents of the supply of gypsum, including whether an impurity is present in the supply of gypsum.

10. The system for manufacturing calcined gypsum according to claim 9, wherein the impurity comprises at least one of salt and chloride.

11. A system for manufacturing a gypsum board, the system comprising:
a mixer, the mixer being adapted to agitate calcined gypsum and water to form an aqueous gypsum slurry;
an ingredient supply system, the ingredient supply system being configured to selectively feed, according to a board formulation, at least water and calcined gypsum to the mixer, the ingredient supply system including a source of calcined gypsum, the source of calcined gypsum associated with the mixer to selectively deliver a feed stream of the calcined gypsum thereto; and
an in-line board control device, the in-line board control device including an x-ray analyzer and a controller in operable arrangement therewith, wherein:
the x-ray analyzer has an x-ray source and a detector, the x-ray source configured to emit an x-ray beam to strike at least a portion of the feed stream of calcined gypsum in a position upstream of the mixer, and the detector configured to measure a response of the feed stream of calcined gypsum to the x-rays emitted from the x-ray source interacting with the calcined gypsum, the x-ray analyzer configured to generate a board control signal indicative of the response measured by the detector, and
the controller configured to adjust at least one of the board formulation and a board line operational parameter based upon the board control signal received from the x-ray analyzer.

12. The system according to claim 11, wherein the board control signal generated by the x-ray analyzer is indicative of the amounts of dihydrate, hem ihydrate, and anhydrate phases in the feed stream of calcined gypsum.

13. The system according to claim 11, wherein the board control signal generated by the x-ray analyzer is indicative of the purity of the feed stream of calcined gypsum, including whether at least one impurity is present in the feed stream of calcined gypsum.

14. The system according to claim 11, wherein the x-ray analyzer comprises an XRD analyzer configured to generate x-ray diffraction data and to generate, using the x-ray diffraction data, the board control signal, the board control signal indicative of the contents of the feed stream of calcined gypsum, including a proportion of at least one phase of calcium phosphate present in the feed stream of calcined gypsum.

15. The system according to claim 11, wherein the x-ray analyzer comprises an XRF analyzer configured to generate x-ray fluorescence data and to generate, using the x-ray diffraction data, the board control signal, the board control signal indicative of the contents of the feed stream of calcined gypsum, including a proportion of at least one phase of calcium phosphate present in the feed stream of calcined gypsum.

16. The system according to claim 11, wherein the x-ray analyzer comprises an XRF analyzer configured to generate x-ray fluorescence data and to generate, using the x-ray diffraction data, the board control signal, the board control signal indicative of the contents of the feed stream of calcined gypsum, including whether an impurity is present in the feed stream of calcined gypsum.

17. The system according to claim 16, wherein the impurity comprises at least one of salt and chloride.

18. The system according to claim 11, wherein the ingredient supply system includes a stucco bin, the stucco bin configured to house therein the source of calcined gypsum, and wherein the x-ray analyzer is disposed between the stucco bin and the mixer.

19. The system according to claim 18, wherein the ingredient supply system includes an elevator, the elevator disposed between the stucco bin and the x-ray analyzer, the elevator configured to receive the feed stream of calcined gypsum from the stucco bin, convey the feed stream of calcined gypsum from the stucco bin to an elevated position, and discharge the feed stream of calcined gypsum therefrom.

20. The system according to claim 1, further comprising:
a calcination unit, the calcination unit including a calcining chamber and a heating unit associated with the calcining chamber, the calcining chamber including an inlet for receiving a supply of gypsum therethrough and into the calcining chamber and an outlet for discharging the source of calcined gypsum from the calcining chamber;
wherein the detector of the x-ray analyzer is configured to measure a response of the source of calcined gypsum to the x-rays emitted from the x-ray source, the x-ray analyzer configured to generate a calcining control signal indicative of the response measured by the detector; and
wherein the controller is configured to adjust at least one operating parameter of the calcination unit based upon the calcining control signal received from the x-ray analyzer.
